(19) United States
(12) Patent Application Publication
(10) Pub. No.: US 2026/0180427 A1
(43) Pub. Date: Jun. 25, 2026

(54) DRIVING CIRCUIT FOR A SWITCHING CIRCUIT

(71) Applicant: STMicroelectronics International N.V, Geneva (CH)

(72) Inventors: Giovanni Sicurella, Catania (CT) (IT); Sandro Rossi, Pavia (IT)

(21) Appl. No.: 19/424,950

(22) Filed: Dec. 18, 2025

(30) Foreign Application Priority Data
Dec. 24, 2024 (IT) 102024000029967

(51) Int. Cl. H02M 1/088; H02M 3/158

(52) U.S. Cl. CPC H02M 1/088; H02M 3/158

(57) ABSTRACT

A driving circuit is provided for switching a switching circuit which has a high-side switch circuit and a low-side switch circuit and a phase node between the high-side switch circuit and the low-side switch circuit. The driving circuit has: a driving voltage regulator with a driving node which provides a driving voltage; a high-side driver which has a supply node configured to be coupled to a bootstrap node of a bootstrap capacitance and to control a switching of the high-side switch circuit; and a low-side driver which has a supply node coupled to the driving node and configured to control a switching of the low-side switch circuit. Furthermore, the driving circuit has a circuitry configured to regulate the coupling between the driving node of the driving voltage regulator and the supply node of the high-side driver.

### CROSS-REFERENCE TO RELATED APPLICATION

This application claims the benefit of Italian Patent Application No. 102024000029967, filed on Dec. 24, 2024, which application is hereby incorporated by reference herein in its entirety.

### TECHNICAL FIELD

The present disclosure generally relates to a driving circuit for a switching circuit and, in particular embodiments, to a switching circuit of a switching voltage converter.

### BACKGROUND

FIG. 1 shows a known voltage converter 1 that provides an output voltage VOUT to a load 3 from an input voltage VIN. The voltage converter 1 comprises a half-bridge circuit 5, which serves as the switching circuit of the voltage converter 1, and a driving circuit 7 that switches the half-bridge circuit 5 as a function of a high-side control signal HS_PWM and a low-side control signal LS_PWM.

The high-side control signal HS_PWM and the low-side control signal LS_PWM are generated by additional components of the voltage converter 1, not shown here, so that the output voltage VOUT is maintained at a desired nominal value.

The half-bridge 5 comprises a high-side switch HS′, formed by an NMOS transistor 8 and a parasitic diode 9 associated with the NMOS transistor 8, and a low-side switch LS′, formed by an NMOS transistor 10 and a parasitic diode 11 associated with the NMOS transistor 10, mutually coupled between the input voltage VIN and the ground GND.

A phase node SW is arranged between the high-side switch HS' and the low-side switch LS′.

An inductor L and a capacitor C are coupled to the phase node SW at the output of the half-bridge 5. The output voltage VOUT drops across the capacitor C.

A bootstrap capacitor CBOOT is coupled between a bootstrap node BOOT of the voltage converter 1 and the phase node SW.

The driving circuit 7 also comprises an internal voltage regulator 13, which is supplied by the input voltage VIN and which provides a driving voltage VDRV to a respective driving node 14, starting from a reference voltage VREF.

The driving circuit 7 comprises a high-side driver 16, which opens and closes the high-side switch HS' as a function of the high-side control signal HS_PWM, and a low-side driver 17, which opens and closes the low-side switch LS' as a function of the low-side control signal LS_PWM.

The low-side driver 17 is supplied by the driving voltage VDRV.

The high-side driver 16 has a supply node 20 that is directly coupled to the bootstrap node BOOT, and a supply reference node that is directly coupled to the phase node SW.

A passive diode 22 is arranged between the driving node 14 of the internal voltage regulator 13 and the supply node 20, allowing charging of the bootstrap capacitor CBOOT.

The supply node 20 of the high-side driver 16 is at a bootstrap voltage Vboot, which drops across the bootstrap capacitor CBOOT.

The use of NMOS transistors to form the high-side HS' and low-side LS' switches of the half-bridge circuit 5 allows obtaining low on-state resistances, compared for example to the use of PMOS transistors, and thus allows obtaining low power consumption.

The bootstrap capacitor CBOOT, in parallel with the high-side driver 16, provides the voltage needed for closing the high-side switch HS' (i.e., for turning on the respective NMOS transistor 8).

According to an approach, an external capacitor 25 (indicated by a dashed line in FIG. 1), also known as a tank capacitor, may be coupled to the driving node 14 of the internal voltage regulator 13, in such a way as to keep the driving voltage VDRV constant during the use of the voltage converter 1 and in particular to avoid oscillations of the driving voltage VDRV during the switching of the half-bridge 5.

However, the external capacitor 25 occupies a large portion of the die area, thereby increasing the cost of converter 1. In particular, integrating the capacitor 25 within the die of converter 1 or within its package entails high production costs for converter 1. Instead, if the external capacitor 25 is used, an additional pin needs to be provided in the converter 1; however, this is not always possible due to the resulting increase in the final application's costs and the ever-increasing trend towards the miniaturization of such devices.

In the absence of the external capacitor 25, the driving voltage VDRV may undergo significant oscillations, preventing proper half-bridge 5 switching and causing malfunctions in the driving circuit 7 and reduced switching performance of the known converter 1.

Furthermore, a figure of merit for a switching voltage converter is the voltage-conversion power efficiency.

One of the known mechanisms that contributes to the power consumption of the voltage converter 1 is the dead-time contribution, i.e., the power consumption that may occur in the time window between the opening of the high-side switch HS' (i.e., the turning off of the respective NMOS transistor 8) and the closing of the low-side switch LS' (i.e., the turning on of the respective NMOS transistor 10).

In fact, during the dead time, the phase node SW discharges through load 3. When the phase node SW has been discharged, the output current recirculates in the parasitic diode 11 of the low-side switch LS′, thus contributing to increasing the power consumption of the converter 1. Consequently, the need is felt to have a dead time as short as possible. At the same time, a dead time that is too short may increase the risk of shoot-through in the voltage converter 1.

Switching performance, power consumption, and area occupation of the known driving circuit 7, and thus of the voltage converter 1, are insufficient for specific applications. is desirable.

### SUMMARY

Technical advantages are generally achieved by embodiments of this disclosure, which describe a switching circuit of a switching voltage converter.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 shows a circuit diagram of a known voltage converter;

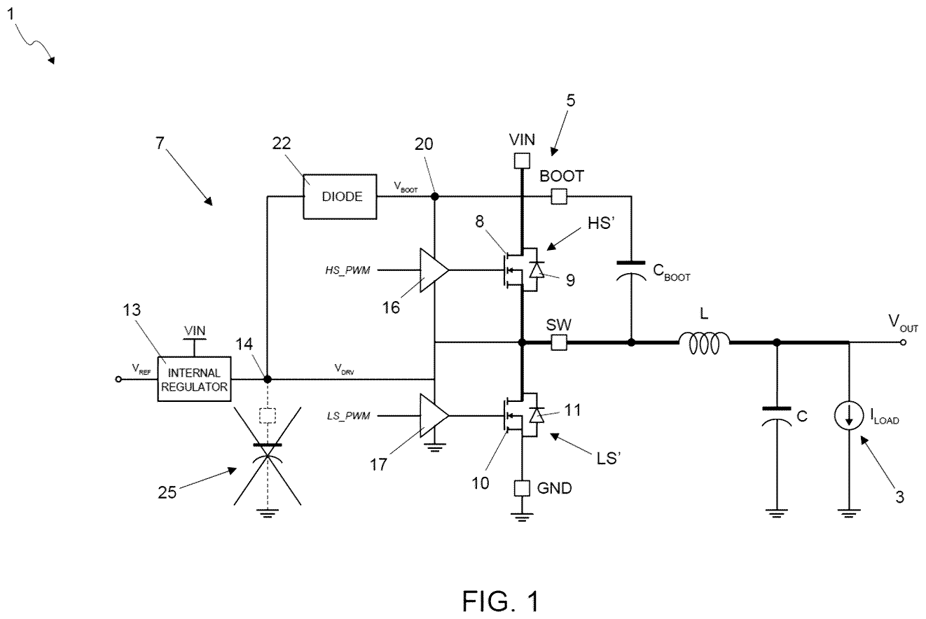

FIG. 2 shows a circuit diagram of a voltage converter;

FIG. 3A shows waveforms of the voltage converter of FIG. 2, in use, in a first condition of use;

FIG. 3B shows waveforms of the voltage converter of FIG. 2, in use, in a second condition of use;

FIG. 4 shows a detailed circuit diagram of a portion of the converter of FIG. 2;

FIG. 5 shows a detailed circuit diagram of a different portion of the converter of FIG. 2; and

FIGS. 6 and 7 show various detailed embodiments of a further portion of the converter of FIG. 2.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

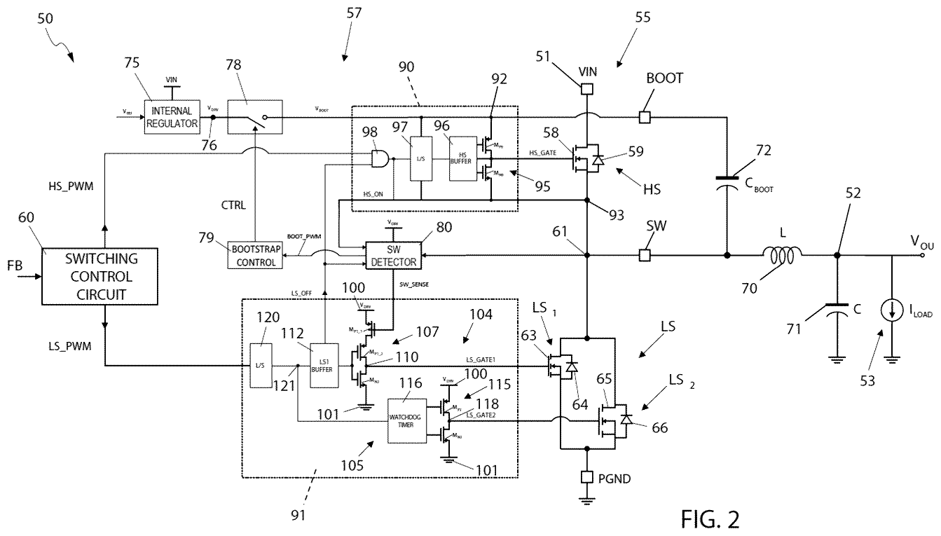

FIG. 2 shows a voltage converter 50 having an input node 51 at an input voltage VIN and an output node 52 at an output voltage VOUT.

The voltage converter 50 is configured to provide the voltage VOUT to a load 53, starting from the input voltage VIN.

In particular, the voltage converter 50 is configured to keep the output voltage VOUT at a nominal value, which may be chosen by a user depending on the specific application.

In the embodiment shown in FIG. 2, the voltage converter 50 is a switching voltage converter. In embodiments the switching voltage converter is a DC-DC converter. Furthermore, in the embodiment of FIG. 2, the voltage converter 50 is a step-down converter, i.e., configured such that the output voltage VOUT is lower than the input voltage VIN.

The voltage converter 50 comprises: a switching circuit which, in the embodiment of FIG. 2, is a half-bridge circuit 55; and a driving circuit 57 which controls the switching of the half-bridge circuit 55.

The driving circuit 57 controls the switching of the half-bridge circuit 55 as a function of a modulated control signal, and in embodiments, a high-side control signal HS_PWM and a low-side control signal LS_PWM.

The high-side control signal HS_PWM and the low-side control signal LS_PWM are pulse-width modulated signals, which are generated by a switching control circuit 6o to control the turning on and turning off durations of the switches of the switching circuit 55, so that the output voltage VOUT is kept equal to the desired nominal value.

For example, the switching control circuit 6o may generate the high-side HS_PWM and low-side LS_PWM control signals as a function of a feedback signal FB indicative of the current value of the output voltage VOUT (and in particular indicative of a difference between the output voltage VOUT and the desired nominal value), so as that the output voltage VOUT is kept substantially constant and equal to the desired nominal value.

The switching control circuit 6o may be configured to perform a voltage or current control of the voltage converter 50, for example, according to a peak or valley control scheme or other control schemes known per se.

The half-bridge circuit 55 comprises a high-side switch circuit HS and a low-side switch circuit LS, mutually coupled between the input node 51 and a reference potential node (here, ground through the ground node PGND of the voltage converter 50).

The high-side switch circuit HS, hereinafter also referred to as the high-side switch HS, is arranged between the input node 51 and the intermediate node 61 of the half-bridge circuit 55. The intermediate node 61 forms a phase node SW of the voltage converter 50. In embodiments, the high-side switch HS is formed, as shown, by an NMOS transistor 58 and may also comprise a parasitic diode 59 associated with the NMOS transistor 58.

The low-side switch circuit LS, hereinafter also referred to as the low-side switch LS, is arranged between the intermediate node 61 and the reference potential node PGND. In embodiments, the low-side switch LS comprises a parallel circuit having a first low-side switch LS1 in a first circuit branch and a second low-side switch LS2 in a second circuit branch parallel to the first circuit branch.

The first low-side switch LS1 is formed, in the embodiment shown, by an NMOS transistor 63 and may comprise a parasitic diode 64 associated with the NMOS transistor 63. The second low-side switch LS2 is formed, in the embodiment shown, by an NMOS transistor 65 and may comprise a parasitic diode 66 associated with the NMOS transistor 65.

The first low-side switch LS1 is configured to allow the flow of a current that is lower than in the second low-side switch LS2. In particular, in the embodiment shown, the NMOS transistor 63 is configured, in the on-state, to allow the flow of a current, and the NMOS transistor 65 is configured, in the on-state, to allow the flow of a current higher than that of the NMOS transistor 63.

In detail, according to an embodiment, the first and the second low-side switches LS1, LS2 may be configured such that, in the presence of a maximum current load IL,max which flows in the inductor IL and when the first low-side switch LS1 is closed (NMOS transistor 63 on) and the second low-side switch LS2 is open (NMOS transistor 65 off), the source-drain voltage of the NMOS transistor 63 (i.e., RDS,on.IL,max) is lower than the threshold voltage of the diode 66 of the second low-side switch LS2; this allows to avoid a recirculation current on the diode 66.

This may be achieved, for example, by appropriately sizing transistors 63 and 65, and in particular by appropriately regulating (in the design step) the ratio between them.

For example, the NMOS transistor 63 may be sized to allow a lower current to flow than in the NMOS transistor 65. For example, the length of the NMOS transistor 63 may be shorter than the length of the NMOS transistor 65.

An inductor 70 of inductance L and an output capacitor 71 of capacitance C are coupled to the phase node SW, at the output of the half-bridge circuit 55. The output voltage VOUT drops across the capacitor 71.

In embodiments, the inductor 70 is coupled between the phase node SW and the output node 52, and the capacitor 71 is coupled between the output node 52 and ground.

A bootstrap capacitor 72 of capacitance CBOOT is coupled between the phase node SW and a bootstrap node BOOT of the voltage converter 50. The bootstrap node BOOT is at a voltage Vboot.

The driving circuit 57 also comprises an internal voltage regulator (hereinafter also referred to as the driving voltage regulator) 75, which is supplied by the input voltage VIN and provides a driving voltage VDRV to a respective output node (hereinafter also referred to as the driving node) 76, starting from a reference voltage VREF.

The internal voltage regulator 75 may be, for example, a linear regulator.

In particular, according to an embodiment, the internal voltage regulator 75 is a capless voltage regulator. In other words, the voltage converter 50 may be free of a dedicated external capacitor (in addition to the bootstrap capacitor 72), which is directly coupled to the respective driving node 76.

The driving circuit 57 further comprises a bootstrap switch circuit 78 and a bootstrap control circuit, which is configured to control the bootstrap switch circuit 78 and comprises, in the embodiment of FIG. 2, a control circuit 79 and a sensing circuit 80.

The bootstrap switch circuit 78 is coupled between the driving node 76 and the bootstrap node BOOT, and is configured to regulate the coupling between the driving node 76 and the bootstrap node BOOT, as a function of a bootstrap control signal CTRL.

In particular, the bootstrap switch circuit 78 is configured to couple the driving node 76 to the bootstrap node BOOT or decouple the driving node 76 from the bootstrap node BOOT, as a function of the bootstrap control signal CTRL.

The bootstrap switch circuit 78 has a switching time between a closed state, wherein it couples the driving node 76 to the supply node 92 of the high-side driver 90, and an open state, wherein it decouples the driving node 76 from the supply node 92; for example, the switching time may be about a few nanoseconds or tens of nanoseconds, depending on the specific configuration and implementation of the bootstrap switch circuit 78.

The bootstrap switch circuit 78 may comprise one or more switches, for example, formed by one or more transistors or electrical elements of different types, depending on the specific implementation.

The sensing circuit 80 is coupled to the phase node SW and configured to monitor the trend of the voltage at the phase node SW and, in response, provide a first regulated signal BOOT_PWM.

In embodiments, the sensing circuit 80 is configured to sense when the phase node SW falls below a voltage threshold. Such a voltage threshold may be chosen such that the voltage Vboot at the bootstrap node BOOT (which follows the voltage VSW at the phase node SW by means of the bootstrap capacitor 72) is low enough not to damage the internal regulator 75 when the switch 78 closes. For example, such a threshold may be approximately lower than 1 V. In other words, the sensing circuit 80 is configured to sense when the phase node SW has discharged.

In the embodiment of FIG. 2, the sensing circuit 80 is also configured to provide a second regulated signal SW_SENSE, hereinafter also referred to as the driver control signal SW_SENSE, indicative of the trend of the voltage at the phase node SW.

The control circuit 79 is configured to receive the first regulated signal BOOT_PWM, and, in response, to provide the bootstrap control signal CTRL.

In embodiments, the bootstrap control signal CTRL is configured to close the bootstrap switch circuit 78, in response to sensing, by the sensing circuit 80, that the phase node SW has fallen below the voltage threshold.

The bootstrap control signal CTRL may be configured to close the bootstrap switch circuit 78 upon the occurrence of a double condition, that is in response to sensing by the sensing circuit 80 that the phase node SW has fallen below the voltage threshold, and in response to receiving a signal which indicates that the turning on control of the low-side switch circuit LS has been provided (i.e., when LS_OFF=0 in the embodiment shown).

The driving circuit 57 further comprises a high-side driver 90, which controls the switching (i.e., opening and closing) of the high-side switch HS; and a low-side driver 91, which controls the switching (i.e., opening and closing) of the low-side switch LS.

In embodiments, the high-side driver 90 controls the switching of the high-side switch HS as a function of the high-side control signal HS_PWM, and the low-side driver 91 controls the switching of the low-side switch LS as a function of the low-side control signal LS_PWM.

The high-side driver 90 has a supply node 92, which is coupled, in particular directly coupled, to the bootstrap node BOOT, and a reference supply node 93, which is coupled, in particular directly coupled, to the phase node SW.

The high-side driver 90 is configured to couple the high-side switch HS, in particular the gate terminal of the NMOS transistor 58, to the supply node 92 or the reference supply node 93, as a function of the high-side control signal HS_PWM.

In embodiments, the high-side driver 90 comprises an output stage 95 arranged between the nodes 92, 93 and, in this embodiment, formed by a PMOS transistor MP0 and an NMOS transistor MN0. In particular, the output stage 95 may be an inverter (wherein the transistors MP0 and MN0 have the gate terminals connected and controlled by the same signal); or, the transistors MP0 and MN0 may be controlled by two different signals generated by a dedicated logic configured to avoid cross-conduction conditions between the two transistors.

The output stage 95 is driven by a respective control circuit starting with the high-side control signal HS_PWM, which, in the embodiment shown, comprises a high-side buffer 96, a level shifter circuit 97, and a logic gate 98 (here, an AND logic gate), cascaded together.

The buffer 96 may be configured to provide current values sufficient to drive the high-side switch HS, or to implement circuits that avoid cross-conduction in the output stage 95.

The level shifter 97 may be configured to couple between the control logic supply domain 60 and the high voltage supply domain (voltages VSW and Vboot).

The logic gate 98 may be useful to prevent the output stage 95 from turning on before the low-side driver 91 receives the turning-off command (i.e., the logic gate 98 may ensure the high-side switch HS turns on only when HS_PWM=1 and LS_OFF=1).

However, the output stage 95 may be controlled by a different circuit, depending on the specific application.

In embodiments, the logic gate 98 receives, at its input, the high-side control signal HS_PWM and the logic signal LS_OFF, and provides, at its output, the logic signal HS_ON.

The logic signal LS_OFF is indicative of the reception, by the low-side driver 91, of the turning off control signal of the low-side switch LS.

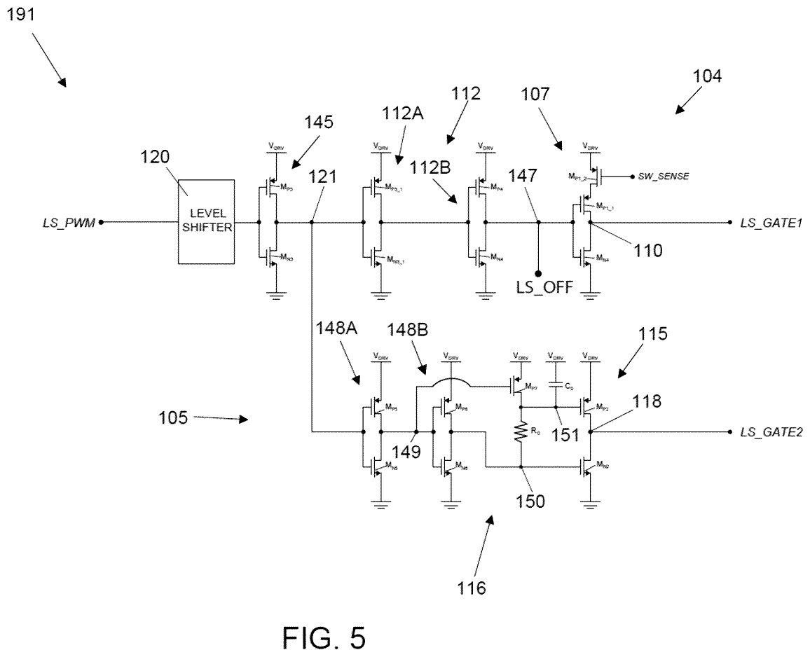

The logic signal LS_OFF may be provided, for example, by the low-side driver 91, as shown in the detailed embodiment of FIG. 4.

In practice, the logic signal HS_ON provided by the logic gate 98 may have the logic value ‘high’ when the high-side control signal HS_PWM indicates the closing of the high-side switch HS and the logic signal LS_OFF indicates the opening of the low-side switch LS.

This may help prevent the high-side switch HS and the low-side switch LS from being on simultaneously, thereby avoiding a current path between the input node 51 and the ground node PGND through the half-bridge circuit 55.

The low-side driver 91 has a supply node 100 coupled to the driving node 76 of the internal voltage regulator 75, i.e., it is at the driving voltage VDRV, and a reference supply node 101 coupled to a reference potential node (here, ground).

In the embodiment of FIG. 2, the low-side driver 91 comprises a first branch 104 configured to control the opening or closing of the first low-side switch LS1, and a second branch 105 configured to control the opening or closing of the second low-side switch LS2.

The first branch 104 of the low-side driver 91 receives the driver control signal SW_SENSE from the sensing circuit 8o and, in response, controls the turning on or turning off of the first low-side switch LS1. In particular, the first branch 104 of the low-side driver 91 turns on the first low-side switch LS1 when the voltage at the phase node SW has fallen below the voltage threshold.

In embodiments, the low-side driver 91 comprises, in the first branch 104, an output stage 107 configured to couple the gate terminal of the NMOS transistor 63 to one of the nodes 100, 101 as a function of the low-side control signal LS_PWM and the signal SW_SENSE.

In some embodiments, the output stage 107 comprises a PMOS transistor MP1_2 and an NMOS transistor MN1, which are driven as a function of the low-side control signal LS_PWM, and a PMOS transistor MP1_1, which is arranged between the first supply node 100 and the PMOS transistor MP1_1 and is driven by the driver control signal SW_SENSE. In particular, the output stage 107 may be an inverter (wherein the transistors MP1_2 and MN1 have the gate terminals connected and controlled by the same signal); or, the transistors MP1_2 and MN1 may be controlled by two different signals generated by a dedicated logic configured to avoid cross-conduction conditions between the two transistors.

The gate terminal of the NMOS transistor 63 of the first low-side switch LS1 is coupled to an intermediate node 110 of the output stage 107, from which it receives a gate control signal LS_GATE1.

The first branch 104 of the low-side driver 91 may also comprise a buffer 112, upstream of the output stage 107. The buffer 112 may drive the output stage 107 as a function of the low-side control signal LS_PWM. The buffer 112 may be useful to introduce a delay in the opening and closing of the first low-side switch LS1. Furthermore, the buffer 112 may be useful to correctly drive the output stage 107.

The logic signal LS_OFF may be provided by the buffer 112; for example, it may be the buffer's output (e.g., the same signal that controls the transistors MP1_2 and MN1) or an internal signal of the buffer 112.

In practice, the second branch 105 is configured to introduce a deadtime (i.e., the delay ΔT) during the closing of the second low-side switch LS2 (the NMOS transistor 65 turning on). In particular, the second branch 105 introduces a fixed deadtime in the turning on of the NMOS transistor 65, that is regardless of the trend of the voltage VSW at the phase node SW.

The delay ΔT may, for example, be of the order of tens of nanoseconds, ranging from 10 ns to 90 ns in some embodiments.

According to an embodiment, the delay ΔT may be chosen to be negligible compared to the minimum Toff of the switching circuit 55. This may ensure a correct operation of the converter 50.

According to an embodiment, the delay ΔT may be chosen such that, below a threshold value (e.g., a few tens of mA, in particular about 10 mA) of the load current Iload at the output, the delay ΔT is lower than the adaptive deadtime introduced by the first branch 104; thus, in this scenario, the second low-side switch LS2 closes before the first low-side switch LS1. On the contrary, above the threshold value of the load current Iload at the output, the delay ΔT is higher than the adaptive deadtime introduced by the first branch 104; thus, in this scenario, the second low-side switch LS2 closes after the first low-side switch LS1. In particular, the low-side driver 91 may be configured to introduce the delay ΔT with respect to the reception of an event of the low-side control signal LS_PWM (e.g., a respective rising edge), which indicates the closing of the low-side switch circuit LS.

In particular, the delay ΔT may be fixed during the use of the voltage converter 50, that is, it may be decided during the design or calibration step of the voltage converter 50 by a user.

In embodiments, the low-side driver 91 comprises, in the second branch 105, an output stage 115 which is configured to couple the gate terminal of the NMOS transistor 65 to one of the supply nodes 100, 101; and a delay circuit (also called “watchdog timer”) 116 which drives the output stage 115 with the delay ΔT with respect to the event of the low-side control signal LS_PWM which indicates the closing of the low-side switch LS.

In particular, the delay circuit 116 may be configured to introduce the delay ΔT only during the closing step of the low-side switch LS and not during the opening step of the low-side switch LS.

The delay circuit 116 may also comprise a buffer for driving the output stage 115.

In some embodiments, the output stage 115 comprises a PMOS transistor MP2 and an NMOS transistor MN2, both driven by the delay circuit 116.

The gate terminal of the NMOS transistor 65 of the second low-side switch LS2 is coupled to an intermediate node 118 of the output stage 115, from which it receives a gate control signal LS_GATE2.

The low-side driver 91 may also comprise a level shifter circuit 120, which has an input for receiving the low-side control signal LS_PWM and an output 121 to which the first and second branches 104, 105 are coupled.

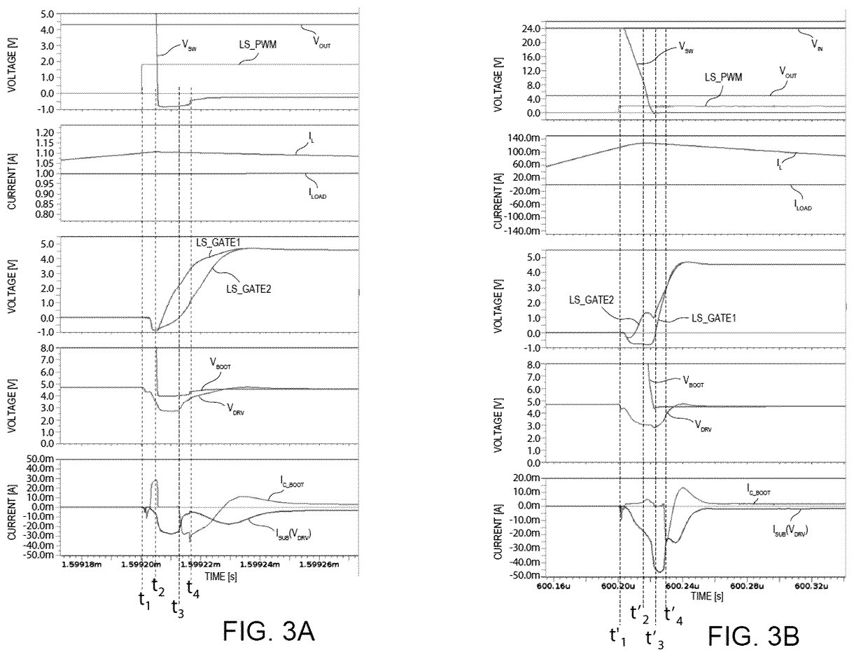

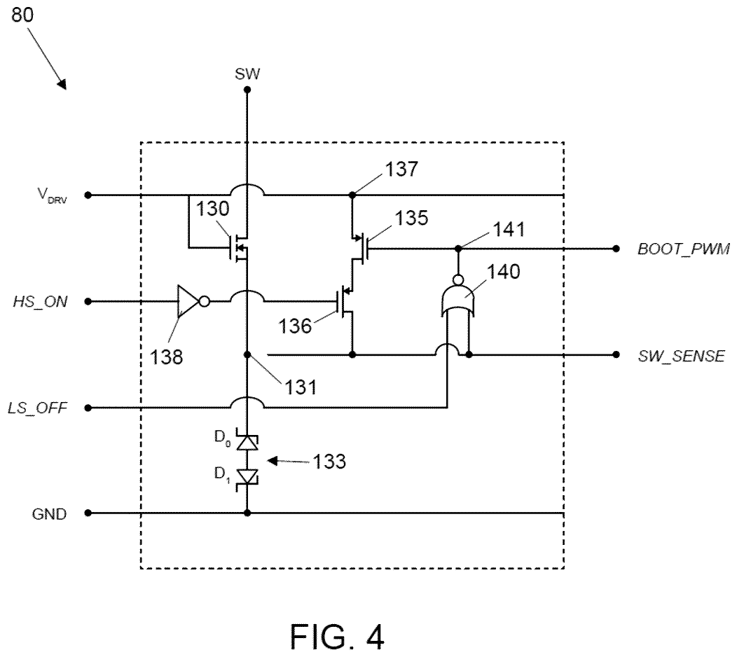

FIG. 3A shows an example of the waveforms of the voltage converter 50 of FIG. 2 in use, with the current ILOAD drawn by the load 53 being high, for example, about 1 A.

In particular, FIG. 3A illustrates an example of the operation of the voltage converter 50 around a switching event (instant t1) of the half-bridge circuit 55, in particular around the opening of the high-side switch HS (i.e., turning off of the NMOS transistor 63) and the closing of the low-side switch LS (i.e., turning on of the NMOS transistor 65).

The closing of the low-side switch LS is controlled by the rising edge of the low-side control signal LS_PWM from the value ‘low’, equal to about 0 V in the example of FIG. 3A, to the value ‘high’, equal to about 1.8 V in the example of FIG. 3A.

Purely by way of example, in FIG. 3A, the output voltage VOUT is kept at the desired value of about 4.5 V, and the driving voltage VDRV provided by the internal regulator 75 is about equal to 5V.

In response to the turning off of the NMOS transistor 63 of the high-side switch LS, the phase node SW is discharged by the load current ILOAD, which flows from the output node 52 through the load 53.

The voltage VSW at the phase node SW decreases until getting, instant t2, below the value ‘low’, for example corresponding to about 0 V in the example of FIG. 3A, and for example up to a voltage of about −1 V.

As to the voltage Vboot at the bootstrap node BOOT, the capacitance CBOOT is charged at the driving voltage VDRV by the driving regulator 75 during the OFF phase (interval Toff) of the converter 50 (during which the voltage VSW at the phase node is low, i.e., about 0 V). During the ON phase of converter 50, the voltage VSW rises to the input voltage VIN. The capacitance CBOOT is sized to discharge negligibly during the ON phase; thus, during the ON phase, the voltage Vboot remains at a value about equal to or slightly lower than VIN+VDRV. In response to the decrease in the voltage VSW, the voltage Vboot at the bootstrap node BOOT also decreases, since the nodes BOOT and SW are coupled through the capacitor 72. At this point, the charge lost by the bootstrap capacitor 72 during the ON phase is restored by the internal regulator 75 by setting Vboot=VDRV.

Before instant t2, the inductor current IL, which flows through the inductor 70, has an increasing trend; after instant t2, the inductor current IL has a decreasing trend.

In response to reaching the value ‘low’ by the voltage VSW of the phase node SW (instant t2), the sensing circuit 80 provides the first regulated signal BOOT_PWM in such a way as to control the closing of the bootstrap switch circuit 78 by the bootstrap control circuit 79, and the second regulated signal SW_SENSE to the low-side driver 91 in such a way as to control the turning on of the PMOS transistor MP1_1.

Thus, after instant t2, the signal LS_GATE1, which controls the gate terminal of the NMOS transistor 63 of the first low-side switch LS1, increases until the turning on (instant t3) of the NMOS transistor 63.

At instant t3, the bootstrap switch circuit 78 closes, and the output node 76 of the internal voltage regulator 75 is connected to the bootstrap node BOOT. The difference between instants t3 and t2 depends on the delays introduced by the bootstrap control circuit 79, which drives the bootstrap switch circuit 78.

The first low-side switch LS1 is thus turned on, at least in part, particularly in the initial part of the turn-on. At the same time, the bootstrap capacitor 72 is disconnected from the output node 76 of the internal voltage regulator 75. In embodiments, while the capacitor 72 is disconnected from the voltage VDRV, the internal regulator 75 provides charge to make the transistors MP1_2 and MN1 switch, through the buffer 112. In practice, due to the delay between instants t2 and t3, even a small portion of the LS1 turning on is handled by the internal regulator 75, without the support of the bootstrap capacitance CBOOT. The rest of the turning-on step is managed by capacitor 72, which is connected to the voltage VDRV.

However, the fact that the first low-side switch LS1 forms only a portion of the entire low-side switch LS and is configured to have a lower current than the second low-side switch LS2 causes the respective output stage 107 to also be lower, thus drawing a low current from the first supply node 101 to the driving voltage VDRV (and thus from the output node 76 of the internal voltage regulator 75 which provides the driving voltage VDRV).

In other words, it is sufficient for the internal voltage regulator 75, during the interval t1-t3, when the capacitance 72 is disconnected from the internal supply node 76, to withstand a low output current to ensure the start of the closing of the first low-side switch LS1.

Furthermore, the quick turning on of the NMOS transistor 63 allows for avoiding the flow of a recirculation current through the parasitic diode 66 of the second low-side switch LS2.

In the example of FIG. 3A, at instant t3, the output node 76 of the internal voltage regulator 75 is coupled to the bootstrap node BOOT as a consequence of the closing of the bootstrap switch circuit 78. As a result, from instant t3 onwards, the switching of the entire low-side switch LS is withstood, together with the internal regulator 75, also by the bootstrap capacitance 72. As evidence of this, the trend of the current ISUB(VDRV) supplied by the regulator 75 and of the current IC_BOOT sensed at the bootstrap node BOOT may be observed in FIG. 3A. From instant t1 to instant t3, the current ISUB(VDRV) assumes negative values (thus the regulator 75 supplies current) while there is no contribution from IC_BOOT. After instant t3, the largest current contribution comes instead from IC_BOOT, which remains until switching is fully completed. After switching the low-side switches LS1 and LS2, the current IC_BOOT becomes positive and opposite to the current ISUB(VDRV). In this step, the charging of the capacitance CBOOT occurs through the internal regulator 75.

The delay circuit 116 delays the closing of the second low-side switch LS2 by the delay ΔT, with respect to the rising edge of the low-side control signal LS_PWM.

In particular, in the example shown in FIG. 3A, the NMOS transistor 65 turns on at instant t4.

In practice, the charging of the gate terminal of the NMOS transistor 65 and, in particular, the turning on of the NMOS transistor 65 occur, at least in part, while the driving node 76 is connected to the bootstrap node BOOT.

In particular, the charging of the gate terminal of the NMOS transistor 65 may proceed entirely while the current at the output of the internal voltage regulator 75 is withstood by the bootstrap capacitor 72.

In this manner, the charging current for the gate terminal of the NMOS transistor 65 is withstood not only by the internal voltage regulator 75 but also by the bootstrap capacitor 72.

FIG. 3B shows a different example of the voltage converter 50 waveforms of FIG. 2, in use under a second condition in which the current ILOAD drawn by the load 53 is low, for example, a few milliamps.

In particular, FIG. 3B illustrates an example of the operation of the voltage converter 50 around a switching event (instant t′1) of the half-bridge circuit 55, in particular around the opening of the high-side switch HS (i.e., turning off of the NMOS transistor 63) and the closing of the low-side switch LS (i.e., turning on of the NMOS transistor 65).

The closing of the low-side switch LS is controlled by the rising edge of the low-side control signal LS_PWM from the value ‘low’, equal to about 0 V in the example of FIG. 3B, to the value ‘high’, equal to about 1.8 V in the example of FIG. 3B.

Purely by way of example, in FIG. 3B, the output voltage VOUT is maintained at the desired value of about 4.5 V, and the driving voltage VDRV provided by the internal regulator 75 is about equal to 5V. Furthermore, in the example of FIG. 3B, the input voltage VIN is about 24 V.

In response to the turning off of the NMOS transistor 63 of the low-side switch LS, the phase node SW is discharged by the load current ILOAD, which flows from the output node 52 through the load 53.

In the example of FIG. 3B, the low load current ILOAD causes the decrease in the voltage VSW at the phase node SW to the value ‘low’ to be slow, in particular, slower than in the example of FIG. 3A.

In embodiments, in the example of FIG. 3B, the time interval wherein the voltage VSW at the phase node SW reaches a value ‘low’ is greater than the delay ΔT introduced by the delay circuit 116 of the low-side driver 91.

Thus, in the example of FIG. 3B, the low-side driver 91 closes the second low-side switch LS2 (instant t′2) before closing (instant t′3) the first low-side switch LS1.

At instant t′3, the sensing circuit 80 senses the reaching of the value ‘low’ by the voltage VSW at the phase node SW and thus provides in response the first and the second regulated signals BOOT_PWM, SW_SENSE, similarly to what has already been discussed with reference to FIG. 3A.

In response, the low-side driver 91 also closes the first low-side switch LS1, and the bootstrap control circuit 79 provides the bootstrap control signal CTRL, coupling the output node 76 of the internal voltage regulator 75 to the bootstrap node BOOT.

Thus, in the example of FIG. 3B, the internal voltage regulator 75 withstands the initial step of charging the gate terminal of the NMOS transistor 65 of the second low-side switch LS2, without the support of the bootstrap capacitor 72; however, following the coupling between the driving node 76 and the bootstrap node BOOT (instant t′3), the further growth of the gate signals LS_GATE1, LS_GATE2 of both NMOS transistors 63, 65 is withstood not only by the internal voltage regulator 75 but also by the bootstrap capacitor 72 (as indicated by the negative values of the current IC_BOOT sensed at the bootstrap node BOOT).

In practice, from instant t′1 to instant t′3, the switching of the second low-side switch LS2 is entirely under the control of the internal regulator 75. However, the partial turning on of the second low-side switch LS2 allows for the quick discharge of the phase node SW at instant t′3, which enables the turning on of the first low-side switch LS1 and sends the closing command of the switch 78. The turning-on delay of the first low-side switch LS1 (from t′3 to t′4), is the time interval wherein the internal regulator 75 withstands the turning on of both low-side switches LS1 and LS2. However, from t′3 onwards, the remaining part of the switching is withstood by the bootstrap capacitance CBOOT. Therefore, the critical moment for the internal regulator 75 remains short.

In this condition of use, there is no recirculation current through the body diodes 64, 66 because the transistors 63, 65 are turned on before the phase node SW is completely discharged.

In addition, the fixed deadtime (delay ΔT) may be set during design step in such a way as to come into play (i.e., such that the second low-side switch LS2 turns-on before the first low-side switch LS1) when specific conditions of use of the converter occur, for example for values of load current Iload which are not typical during the application of the converter 50 or which are below the thresholds for which other known control mechanisms for improving the efficiency at low load are activated (e.g., pulse skip, PFM techniques, etc.).

In a different operating condition in which the output node 52 of the voltage converter 50 is connected to a high impedance, the phase node SW does not discharge when the high-side switch HS opens. Thus, the respective voltage VSW remains at the value ‘high’ until the low-side switch LS closes. Thus, in this scenario as well, the second low-side switch LS2 closes before the first low-side switch LS1. In response to the closing of the second low-side switch LS2, the voltage VSW at the phase node SW decreases to the value ‘low’. In response to sensing a decrease in voltage VSW by the SW sensing circuit 80, the first low-side switch LS1 is also closed, and the output node 76 of the internal voltage regulator 75 is coupled to the bootstrap node BOOT, as described for the example of FIG. 3B.

Thus, the driving circuit 57 of the voltage converter 50 enables proper switching of the half-bridge circuit 55, even with an internal voltage regulator of the capless type.

In other words, the fact that the driving circuit 57 is configured to couple and decouple the bootstrap node BOOT to the output node 76 of the internal regulator 75 allows the bootstrap capacitor 72 to serve as a tank capacitor for the internal regulator 75 during transitions of the half-bridge 55.

At the same time, the driving circuit 57 allows the voltage converter 50 to maintain a high conversion power efficiency.

The driving circuit 57 has a simple design and a low area occupation.

FIG. 4 shows a detailed embodiment of the sensing circuit 80. The sensing circuit 80 comprises a switch, in particular an NMOS transistor 130, arranged between the phase node SW and an internal node 131 and driven by the driving voltage VDRV.

A pair of Zener diodes 133 in a back-to-back configuration may be arranged between the internal node 131 and the ground GND. This protects the output SW_SENSE.

A series circuit formed by a PMOS transistor 135 and an NMOS transistor 136 is arranged between a supply node 137, which is coupled to the driving voltage VDRV, and the internal node 131.

The NMOS transistor 136 is driven by an inverter 138, which receives the logic signal HS_ON at its input.

A logic gate 140, here of the NOR type, has a first input where it receives the logic signal LS_OFF and a second input coupled to the internal node 131. The logic gate 140 has an output 141 coupled to the gate terminal of the PMOS transistor 135.

The first regulated signal BOOT_PWM, provided at the output by the sensing circuit 80, corresponds to the signal at the output node 141 of the logic gate 140.

In practice, in the embodiment of FIG. 4, the voltage threshold used by the sensing circuit 80 corresponds to the logic threshold of the NOR logic gate 140.

The second regulated signal SW_SENSE provided at the output by the sensing circuit 80 corresponds to the signal at the internal node 131.

However, it will be clear to the person skilled in the art that the sensing circuit 80 may be implemented in a manner other than that shown. For example, it may have a different number of switches, logic gates, etc., depending on the specific application and implementation.

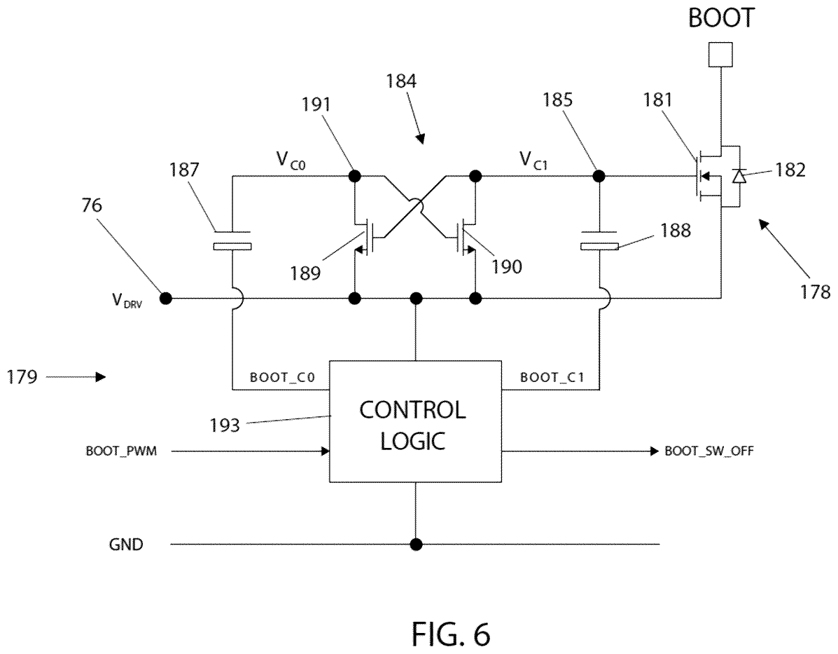

FIG. 5 shows a different detailed embodiment of the low-side driver 191 of the driving circuit 57.

The low-side driver 191 comprises a further inverter 145, at the output to the level shifter 120, having a PMOS transistor MP3 and an NMOS transistor MN3.

The buffer 112 of the first branch 104 is formed, in this embodiment, by two inverters 112A, 112B cascaded to each other.

The inverter 112A, arranged between the driving voltage VDRV and ground, has its input connected to the node 121 and its output connected to the input of the inverter 112B, also arranged between the driving voltage VDRV and ground.

In embodiments, the inverter 112A is formed by a PMOS transistor MP3_1 and an NMOS transistor MN3_1; the inverter 112B is formed by a PMOS transistor MP4 and an NMOS transistor MN4.

The output 147 of the inverter 112B is coupled to the input of the output stage 107.

The logic signal LS_OFF corresponds, in this embodiment, to the voltage at the output 147 of the inverter 112B.

The delay circuit 116 comprises, in the embodiment of FIG. 5, two inverters 148A, 148B supplied between the driving voltage VDRV and the ground and cascaded to each other.

The output node 149 of the inverter 148A is coupled to the input of the inverter 148B.

In embodiments, the inverter 148A comprises a PMOS transistor MP5 and an NMOS transistor MN5 and the inverter 148B comprises a PMOS transistor MP6 and an NMOS transistor MN6.

The output 150 of the inverter 148B forms an output of the delay circuit 116 and is coupled to the gate terminal of the NMOS transistor MN2 of the output stage 115.

The delay circuit 116 further comprises a circuit RC configured to set the delay ΔT and comprising, in this embodiment, a capacitor C0, a resistor Ro, and a switch (here a PMOS transistor MP7).

The PMOS transistor MP7 is arranged between the driving voltage VDRV and a further output 151 of the delay circuit 116, in parallel with the capacitor C0. It has the gate terminal coupled to the output 149 of the inverter 148A. The resistor Ro is arranged between the outputs 150, 151 of the delay circuit 116.

The output 151 is coupled to the gate terminal of the PMOS transistor MP2 of the output stage 115.

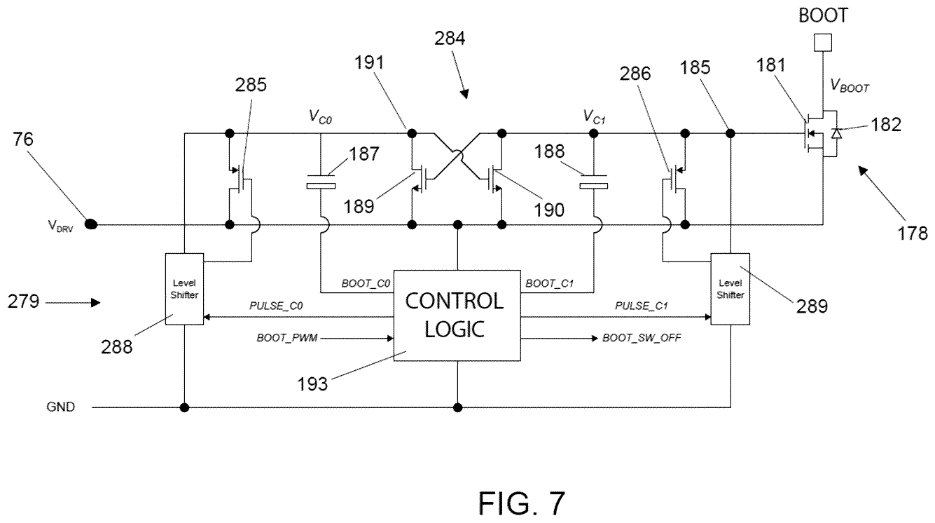

FIG. 6 shows a portion of the driving circuit 57 of FIG. 2, according to an embodiment.

In embodiments, FIG. 6 shows the bootstrap control circuit, here indicated by 179, and the bootstrap switch circuit, here indicated by 178, of the driving circuit 57.

The bootstrap switch circuit 178 is formed by a transistor, in particular an NMOS transistor 181, and a parasitic diode 182 associated with the NMOS transistor 181.

The bootstrap control circuit 179 comprises a charge pump circuit 184 configured to provide a voltage VC1 to an output node 185 of the bootstrap control circuit 179, thereby enabling the NMOS transistor 181 to turn on.

The gate terminal of the NMOS transistor 181 is coupled to the output node 185.

In practice, the bootstrap control signal CTRL corresponds to the voltage VC1 at the output node 185.

In embodiments, the charge pump circuit 184 comprises two capacitors 187, 188 and a pair of switches, here NMOS transistors 189, 190.

The NMOS transistor 189 is coupled between the output node 76 of the internal voltage regulator 75 (i.e., it is at the driving voltage VDRV) and a node 191. The NMOS transistor 190 is coupled between the output node 76 of the internal voltage regulator 75 (i.e., it is at the driving voltage VDRV) and the output node 185.

The gate terminal of the NMOS transistor 189 is coupled to the output node 185, and the NMOS transistor 190 is coupled to the node 191.

The bootstrap control circuit 179 also comprises a control logic 193 which receives the first regulated signal BOOT_PWM and provides, in response, a control signal BOOT_C0 to a terminal of the capacitor 187 and a control signal BOOT_C1 to a terminal of the capacitor 188.

In use, the control logic 193 is configured such that the control signal BOOT_C0 assumes the value ‘high’ and the control signal BOOT_C1 assumes the value ‘low’ when the first regulated signal BOOT_PWM has the value ‘low’, that is, when it indicates that the voltage VSW at the phase node SW is high.

In this case, the voltage VC0 at node 191 (i.e., at the other end of the capacitor 187) is higher than the driving voltage VDRV. Consequently, when the transistor 190 is on, the voltage VC1 at the output node 185 equals the driving voltage VDRV, and thus both the transistor 189 and the transistor 181 are off.

Thus, in this case, the driving node 76 is decoupled from the bootstrap node BOOT.

On the contrary, the control logic 193 is configured such that the control signal BOOT_C1 assumes the value ‘high’ and the control signal BOOT_C0 assumes the value ‘low’ when the first regulated signal BOOT_PWM has the value ‘high’, that is, when it indicates that the voltage VSW at the phase node SW is low. Thus, in this case, the transistor 181 is on and the output node 76 is coupled to the bootstrap node BOOT.

The charge pump 184 thus appropriately opens and closes the switch 178, generating the bootstrap control signal VC1 from the driving voltage VDRV.

Furthermore, the charge pump 184 allows to have no static current consumption.

The control logic 193 may also be configured to provide, at the output, a signal BOOT_SW_OFF indicating when the switch 178 is open; for example, it has the logic value ‘high’ when the switch 178 is open. The signal BOOT_SW_OFF may serve as a feedback signal to the driving circuit 57.

FIG. 7 shows a different embodiment of the bootstrap control circuit, here indicated by 279, wherein the same reference numbers indicate elements in common with the embodiment of FIG. 6.

The charge pump circuit, here indicated by 284, of the bootstrap control circuit 279 also comprises, in addition to what has been discussed with reference to FIG. 6, two switches, in particular a PMOS transistor 285 driven by a signal PULSE_C0 provided by the control logic 193, and a PMOS transistor 286 driven by a signal PULSE_C1 provided by the control logic 193.

The PMOS transistor 285 is coupled between the node 191 and the output node 76 at the driving voltage VDRV. The PMOS transistor 286 is coupled between the output nodes 185 and 76 at the driving voltage VDRV.

The bootstrap control circuit 279 also comprises a level shifter circuit 288, which receives the signal PULSE_C0 and adapts it to the voltage necessary to drive the PMOS transistor 285, and a level shifter circuit 289, which receives the signal PULSE_C1 and adapts it to the voltage necessary to drive the PMOS transistor 286.

The control logic 193 is configured to provide the signal PULSE_C0 in such a way as to turn on the PMOS transistor 285 for a short time interval, for example about 10 ns, during the falling edge of the first regulated signal BOOT_PWM, and to provide the signal PULSE_C1 in such a way as to turn on the PMOS transistor 286 for a short time interval, for example about 10 ns, during the rising edge of the first regulated signal BOOT_PWM.

In general, the duration of the pulses PULSE_C0, PULSE_C1 may be higher and comprise the rising times of the signals BOOT_C1 and BOOT_C0. This allows switch 285 to remain on, keeping switch 190 off during the rise of VC1. In this way, it is possible to ensure that the capacitance 188 does not discharge through the transistor 190 during the rise. Once the rise ends, the transistor 189 is certainly on, and only then does the pulse that keeps the transistor 285 on end.

The same considerations, with the positions inverted, may be made for capacitance 187 and node VC0.

In practice, the transistors 285, 286 form a circuit configured to enable or disable the charge pump circuit 284 based on the first regulated signal, BOOT_PWM.

Thus, the bootstrap control circuit 279 is configured to ensure that the NMOS transistors 189, 190 of the charge pump circuit 284 are off during the switching of the half-bridge circuit 55. In this manner, it is possible to prevent, in use, that fluctuations of the driving voltage VDRV during switching of the half-bridge circuit 55 cause the inadvertent turning on of the transistors 189, 190, and thus the discharge of the capacitances 187 and 188 during the rises of BOOT_C0 and, respectively, BOOT_C1.

Finally, modifications and variations may be made to the voltage converter described and illustrated here without thereby departing from the scope of the present invention, as defined in the attached claims.

For example, the switches of the driving circuit 57 or the half-bridge circuit 55 may be implemented using electrical elements other than MOS transistors, such as bipolar or other transistors.

For example, the type of transistor (NMOS, PMOS) may be reversed with respect to what has been described and illustrated; in such a case, the respective driving circuits and driving signals may be adapted accordingly.

For example, the output circuit of the voltage converter 50, shown in FIG. 2 and formed by the capacitors 72, 71, and the inductor 70, may comprise electrical elements other than those shown, depending on the specific application, the specific load 53 coupled to the converter 50, etc.

For example, one or more of the bootstrap capacitors 72, the capacitor 71, and the inductor 70 may be discrete or integrated elements depending on the specific application.

In general, the bootstrap capacitor 72 may be a capacitance having a capacitance CBOOT implemented through a capacitor, that is integrated or discrete, or through a different electrical element or circuit configured to introduce the capacitance CBOOT between the nodes BOOT and SW.

For example, the half-bridge circuit 55 may be a different switching circuit comprising a different number of high-side or low-side switches, depending on the specific application.

In addition or alternatively, the switching circuit may comprise further half-bridge circuits, depending on the specific voltage converter intended to be implemented (e.g., buck, boost, buck-boost, or other known types of switching voltage converters).

For example, the logic values ‘high’ and ‘low’ may be inverted with respect to what has been discussed above and the respective logic circuits adapted accordingly, in a manner which is obvious per se to the person skilled in the art.

For example, the driving circuit discussed here may be used to drive a switching circuit integrated (or incorporated) within an electronic device other than a switching voltage converter. In particular, the driving circuit may be used to drive a switching circuit having at least one half-bridge circuit comprising two or more NMOS transistors.

Finally, the different embodiments described above may be combined to provide further solutions.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A driving circuit for switching a switching circuit, the driving circuit comprising:
a driving voltage regulator having a driving node and configured to provide a driving voltage to the driving node;
a high-side driver having a first supply node couplable to a bootstrap node of a bootstrap capacitance and configured to control switching of a high-side switch circuit of the switching circuit;
a low-side driver having a second supply node coupled to the driving node and configured to control switching of a low-side switch circuit of the switching circuit, wherein a phase node is arranged between the high-side switch circuit and the low-side switch circuit; and
regulating circuitry configured to regulate coupling between the driving node and the first supply node.

2. The driving circuit of claim 1, wherein the regulating circuitry comprises:
a bootstrap control circuit configured to:
monitor a voltage at the phase node, and
provide a bootstrap control signal as a function of the voltage at the phase node; and
a bootstrap switch circuit configured to regulate the coupling between the driving node and the first supply node as a function of the bootstrap control signal.

3. The driving circuit of claim 2, wherein the bootstrap control signal controls the bootstrap switch circuit such that the bootstrap switch circuit couples the driving node to the first supply node in response to sensing that the voltage at the phase node is less than a first voltage threshold.

4. The driving circuit of claim 3, wherein the first voltage threshold is less than or equal to 1 V.

5. The driving circuit of claim 2,
wherein the low-side switch circuit comprises a first low-side switch and a second low-side switch, wherein the bootstrap control circuit is configured to provide a driver control signal based on the voltage at the phase node, and
wherein the low-side driver is configured to control closing of the first low-side switch, the second low-side switch, or both, based on the driver control signal.

6. The driving circuit of claim 4, wherein the low-side driver is configured to close the first low-side switch in response to sensing that the voltage at the phase node is less than a second voltage threshold.

7. The driving circuit of claim 6, wherein the second voltage threshold is less than or equal to 1V.

8. The driving circuit of claim 5, wherein the low-side driver comprises a delay circuit configured to introduce a delay in closing of the second low-side switch, the delay being independent of whether the voltage at the phase node is less than the second voltage threshold.

9. The driving circuit of claim 1,
wherein, to close the low-side switch circuit, the low-side driver is configured to couple the low-side switch circuit to the second supply node,
wherein, to open the low-side switch circuit, the low-side driver is configured to decouple the low-side switch circuit from the second supply node,
wherein, to close the high-side switch circuit, the high-side driver is configured to couple the high-side switch circuit to the first supply node, and
wherein, to open the high-side switch circuit, the high-side driver is configured to decouple the high-side switch circuit from the first supply node.

10. The driving circuit of claim 9, wherein the low-side driver comprises:
a first branch comprising a first output stage having a first PMOS transistor and a first NMOS transistor and a second PMOS transistor arranged between the supply node of the low-side driver and the first PMOS transistor;
a second branch comprising a second output stage comprising a third PMOS transistor and a second NMOS transistor.

11. The driving circuit of claim 10, wherein the second branch further comprises a delay circuit connected to a respective gate terminal of the third PMOS transistor and the second NMOS transistor, the delay circuit being configured to introduce a fixed deadtime in a turning-on of the low-side switch circuit.

12. The driving circuit of claim 10, wherein the first branch further comprises a buffer circuit connected to a respective gate terminal of the first PMOS transistor and a first NMOS transistor.

13. The driving circuit of claim 10, wherein the low-side driver further comprises a level shifter circuit connected upstream of the first and the second branches.

14. The driving circuit of claim 10, wherein the low-side switch circuit comprises a first low-side switch and a second low-side switch, wherein the first branch of the low-side driver is connected to a gate terminal of the first low-side switch and the second branch of the low-side driver switch is connected to a respective gate terminal of the second low-side switch.

15. The driving circuit of claim 2,
wherein the bootstrap switch circuit comprises a switch, wherein the bootstrap control signal is configured to open and close the switch, and
wherein the bootstrap control circuit comprises a charge pump circuit configured to generate the bootstrap control signal from the driving voltage.

16. The driving circuit of claim 15,
wherein the bootstrap control circuit comprises a sensing circuit configured to generate a first regulated signal based on the voltage at the phase node,
wherein the charge pump circuit is configured to generate the bootstrap control signal based on the first regulated signal, and
wherein the bootstrap control circuit further comprises an enabling circuit configured to enable or disable the charge pump circuit based on the first regulated signal.

17. The driving circuit of claim 1, wherein the driving voltage regulator is a capless voltage regulator.

18. An electronic device, comprising:
a switching circuit including a high-side switch circuit, a low-side switch circuit, and a phase node arranged between the high-side switch circuit and the low-side switch circuit;
a bootstrap capacitance coupled between a bootstrap node and the phase node; and
a driving circuit configured to switch the switching circuit, the driving circuit comprising:
a driving voltage regulator having a driving node and configured to provide a driving voltage to the driving node,
a high-side driver having a first supply node configured to be coupled to the bootstrap node and configured to control switching of the high-side switch circuit,
a low-side driver having a second supply node coupled to the driving node of the driving voltage regulator and configured to control switching of the low-side switch circuit, and
regulating circuitry configured to regulate coupling between the driving node and the first supply node.

19. The electronic device of claim 18,
wherein the low-side switch circuit comprises a first circuit branch that includes a first low-side switch and a second circuit branch that includes a second low-side switch arranged in parallel with the first circuit branch between the phase node and a reference node,
wherein the first low-side switch is configured to allow a flow of a first current between the phase node and the reference node, and
wherein the second low-side switch is configured to allow a flow of a second current between the phase node and the reference node, the first current being lower than the second current.

20. The electronic device of claim 19,
wherein the electronic device is a switching voltage converter having an input node configured to receive an input voltage and an output node configured to provide an output voltage from the input voltage,
wherein the high-side switch circuit is arranged between the input node and the phase node,
wherein the low-side switch circuit is arranged between the phase node and the reference node,
wherein the voltage converter further comprises a switching control circuit configured to provide a high-side control signal and a low-side control signal as a function of a difference between the output voltage and a nominal voltage,
wherein the low-side driver is configured to control switching of the low-side switch circuit as a function of the low-side control signal, and
wherein the high-side driver is configured to control switching of the high-side switch circuit as a function of the high-side control signal.
